(19) United States
(12) Patent Application Publication
(10) Pub. No.: US 2002/0194054 A1
(43) Pub. Date: Dec. 19, 2002

(54) Internet based qualitative research method and system

(76) Inventor: Renee Frengut, Boca Raton, FL (US)

Correspondence Address: DARBY & DARBY P.C., 805 Third Avenue, New York, NY, 10022, US

(21) Appl. No.: 09/883,590

(22) Filed: Jun. 18, 2001

(51) Int. Cl. G06F 17/60

(52) U.S. Cl. 705/10

(57) ABSTRACT

One embodiment of the present invention provides an improved qualitative market research method and system such that candidates for the market research study are dynamically chosen and selected over a distributed computer network such that at any given time the set of market research candidates optimally fits a predefined preference specified by the client sponsoring the qualitative market research study which are verifiable by the real-time audio and video input from the candidates.

### FIELD OF THE INVENTION

The present invention relates generally to the field of market research. More particularly, the present invention relates to qualitative market research methods and systems conducted over a distributed computer network wherein the market research participants have been dynamically chosen so as to ensure that the final pool of market research participants most closely resembles the consumer or potential consumer base the sponsoring company wishes to probe.

### BACKGROUND OF THE INVENTION

Market research studies are generally qualitative or quantitative in nature. Quantitative studies consist of a large number of samples with results that are easily tabulated for statistical purposes. Qualitative studies, however, comprise a smaller sample set wherein the results consist of open-ended discussions which provide substantive feedback that is often directive in nature. These discussions are often between a professional moderator and a representative sample of the sponsoring company's current and/or potential consumer base. Quantitative studies usually present participants with close-ended questions having pre-formulated, and consequently easily analyzed, responses. While the benefit of quantitative research is that it is statistically projectable, the benefit of qualitative research is that it is directional and substantive. Usually, qualitative studies involve a skilled moderator who creates an in-depth and flexible interview structure, which is nonexistent in quantitative studies.

Currently, qualitative moderators conduct interviews in research facilities globally located. Typically these facilities are located in major metropolitan areas along major airline routes. Consequently, attracting qualitative research participants from small or medium sized towns has proven difficult. Small or medium sized town participants might need to drive for hours or need to take two or more airplanes, simply to reach the study. Asking focus group participants to make such travel sacrifices has proven not only impractical, but also extremely costly. As a result, the small to medium size-town segment of the sponsoring client's consumer or potential consumer base is often times not probed.

However, the benefit of these research facilities is that they equip interview rooms with one-way mirrors and intimate settings such that participant reaction is easily observed by the sponsoring client. The sponsoring client represents the company gauging consumer response to the company's service or product. Qualitative studies typically involve a moderator who conducts an interview with 1-10 participants whom the sponsoring company has chosen as a representative population of the sponsoring company's current or potential consumer base. Consequently, while qualitative studies are generally more informative than quantitative studies, they are also more expensive on a per interview basis, time consuming and travel intensive than quantitative studies.

A number of companies have attempted to replicate the qualitative research experience over the Internet. However, to date, prior art attempts have been unsuccessful. None of the Internet based market research studies have created a virtual market research study or a virtual communication facility. Often times, the video stream is slow, the picture quality is poor, and more often than not the benefits of qualitative market research studies have been compromised. For example, many existing Internet based qualitative market research studies are conducted using online chat, whereby moderators and participants communicate through keystrokes. However, this question and answer format eliminates participant body language and facial expressions from the market research study. Another, prior art attempt involves taping a study in progress and transmitting the signal to the sponsoring client across the Internet or phone lines. One problem with this type of focus group is that participant travel costs and time are not alleviated. Participants still must travel to get to the focus group study and consequently middle to small town size participants will be at large absent from the study. Some examples of these Internet based prior art techniques include: www.greenfieldonline.com; www.harrisinteractive.com; and www.activegroup.net: and www.e-focusgroups.com.

Greenfield Online is one Internet based market research company. Greenfield Online allows sponsoring clients to view a chat room market research group in real time or provides sponsoring clients with market research study transcripts. There is no audio or video component to the chat room. Consequently, informative facial expressions, body expressions, intonations, etc. are lost with the Greenfield Online technique. Moreover, there is no way to verify that the participant responding to the moderator's questions is in fact who the sponsoring client expects the participant to be. Participant veracity is critical to the sponsoring client who wants an accurate sample of their current or potential consumer base polled. With the Greenfield Online approach, there is no way to ensure that demographic information and market research data answers match the participant typing in the chat room.

Another prior art technique is represented with the Harris Interactive prior art. Like Greenfield Online, Harris Interactive enables an “online” chat room market research group. Thus, Harris Interactive, like the Greenfield Online approach censors participant body language from the study. Besides the “online” chat room format, Harris Interactive offers a bulletin board style focus group. With the bulletin board style focus group, focus group questions remain indefinitely on the Web site for participants to answer at their leisure. However, as with the chat room set-up, the bulletin board format results in first hand participant reaction loss.

As mentioned above, another typical internet-based qualitative research study involves simply transmitting a focus group signal over the Internet or phone lines to a sponsoring client's device. Activegroup.com is an example of this type of prior art. Essentially, the sponsoring client views the focus group through the video-conferencing facilities of a research facility. Activegroup does not eliminate travel burdens for the participants. Essentially, Activegroup is a taped market research group. As a result, Activegroup presents the same participant pool constraints as traditional focus groups. The virtual focus group or virtual communication facility experience has not been recreated. The moderators and participants do not communicate through audio/video capturing mechanisms and consequently this video conferenced focus group is not easily modifiable. For example, should the sponsoring client wish that focus group participants not observe the reactions of other participants mid-study, the sponsoring client can not easily mandate a mid-study format change without requiring physically separating participants in separate rooms. With the videotaped focus groups, such as Activegroup, the focus group itself is not virtual. The participants are not participating over the Internet and moderators are not communicating over the Internet. This virtual environment is critical because it facilitates virtual conversations between participants and moderators and between moderators and sponsoring clients. The virtual environment allows sponsoring clients to modify the focus group mid-study without much added inconvenience. The sponsoring client may wish the moderator to ask more poignant questions; focus the market research study on a particular participant; compare participant response when participant reactions are censored from one another. The virtual focus group easily facilitates mid-study changes, which taped focus groups such as Activegroup cannot promote.

Finally, e-focusgroups.com provides the same chat and bulletin board typing chat formats as Greenfield Online and Harris Interactive but e-focusgroups offers a “secured” environment. Once again video and audio capturing mechanisms are absent from e-focusgroup.com. Accordingly, first hand observable accounts of participant reaction are lost, as is the mid-dialogue study alteration capability.

Accordingly, it would be advantageous to provide an improved qualitative research method and system recreating a virtual communication facility such that the time commitment and costs are minimized without comprising the diverse participant pool and the substantive feed-back provided by the behavior patterns and verbal responses observed by the sponsoring client.

### THE SUMMARY OF THE INVENTION

A preferred embodiment of the present invention is a qualitative market research system and method conducted over a distributed computer network wherein each market research participant is dynamically chosen ensuring an ideal consumer reflection of the sponsoring company's current or potential consumer base. The qualitative system and method according to a preferred embodiment involves a moderator and a market research participant communicating through devices having distributed computer network access and audio/video capturing mechanisms or devices. In addition, besides the moderators and participants, a preferred embodiment envisions the sponsoring client observing both participant responses and images through a separate device also connected to the distributed computer network.

A preferred embodiment of the present invention entails market research participants and moderators logging onto a Web site at a given time with a specific market research ID and pass code. Once logged onto the network, market research participants and moderators participate in a virtual focus group in which both parties view: each other and the product or service being evaluated. Sometimes, the participants also view images and responses of other participants depending on the sponsoring companies directive. Consequently, on each participant's screen there are multiple video images: the participant's own image, the moderator's image, the stimulus (presented on separate Web pages), and the participant's submitted response to the stimulus. Similarly, each moderator also views multiple images. The moderator views each participant's image and responses. When the sponsoring client is involved, the sponsoring client observes the entire study anonymously thereby simulating the one-way mirror experience of research facilities. Consequently, the sponsoring client's computer need not have an audio/video capturing mechanism, but should have an observing mechanism and communication device for dialogues with the moderator.

Prior to conducting the qualitative study, a preferred embodiment of the present invention entails dynamically choosing focus group and individual interview participants over a distributed computer network such that an ideal consumer market pool is accumulated. First, a diverse group of potential candidates are invited through telephones, direct mailings, e-mail advertisements, or other such modes of direct solicitation. Once a diverse potential candidate pool has been acquired, the potential candidate pool is compared with the ideal consumer pool dictated by a template often times provided by the sponsoring company. Candidates who most closely resemble participants in the ideal consumer pool at any given time are selected and compensated while unselected potential candidates are rejected without pay. The candidates receive audio/video capturing mechanisms and are instructed to log onto the market research study at a given time. Unlike prior art techniques which eliminated large segments of the consumer or potential consumer pool, due to travel constraints, the present embodiment taps into all segments of the consumer pool. The only prerequisite is that participants have Internet access. The Internet access can be located at a number of locations, which include but are not limited to, home, work, research facilities, and apartment complexes. With Internet as the only requirement, market research study costs are significantly reduced.

Participants represent a first portion of the set of candidates and are the consumers who actually partake in the market research study. Participant presence is monitored and verified throughout the market research study. Participants whose presence has been verified will be paid a first sum. Candidates, will also be paid, but the candidate's sum will be a reduced version of the participant's first sum.

### BRIEF DESCRIPTION OF THE DRAWINGS

The foregoing and other features of the present invention will be more readily apparent from the following detailed description and drawings of illustrative embodiments of the invention wherein like reference numbers refer to similar elements throughout several views and in which;

FIG. 1a is an exemplary flow diagram depicting the enrollment process for a general population sample in accordance with one embodiment of the present invention;

FIG. 1b is an exemplary flow diagram depicting the enrollment process for a corporate/membership population sample in accordance with one embodiment of the present invention;

FIG. 2 is an exemplary flow diagram depicting the process involved in conducting a qualitative study in accordance with one embodiment of the present invention;

FIG. 3 represents an exemplary network arrangement of the qualitative study in accordance with one embodiment of the present invention;

FIG. 4 represents an exemplary flow diagram depicting the process involved in dynamically selecting a set of candidates;

FIG. 5 represents an exemplary network arrangement for dynamically choosing a market research group in accordance with one embodiment of the present invention; and

FIG. 6 represents an exemplary template system for dynamically modifying a template to select a set of candidates in accordance with another embodiment of the present invention.

### DETAILED DESCRIPTION OF THE PREFERRED EMBODIMENTS

By way of overview, one embodiment of the present invention involves a moderator and a market research participant participating in a virtual focus group or individual interview. The parties communicate through devices having distributed computer access and audio/video capturing mechanisms. Sometimes, the sponsoring client observes the virtual communication facility through a separate device also connected to the distributed computer network. In accordance with a preferred embodiment, the qualitative study is conducted such that when market research participants, moderators, and sponsoring clients log onto a given Web site at a predetermined time all parties involved can observe the study in real time.

The market research participants are selected in accordance with a further embodiment of the present invention. According to a preferred embodiment, market research candidates are solicited either directly or indirectly. The candidates are then chosen from an accumulated candidate pool such that the chosen participants most closely represent the ideal consumer base specified by a template usually provided by the sponsoring client.

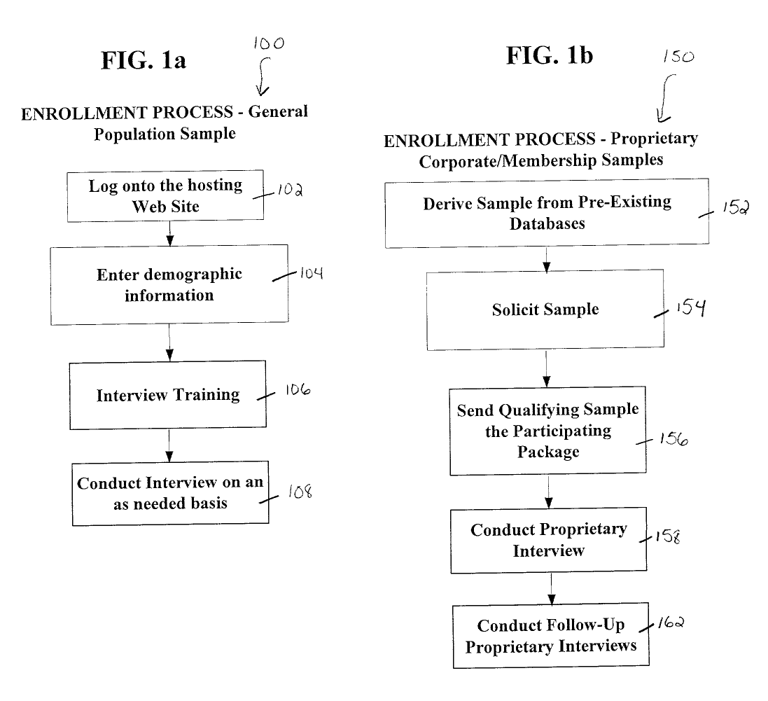

FIG. 1 a represents an exemplary flow diagram depicting the enrollment process for a general population sample in accordance with a preferred embodiment of the present invention.

In step 102, the potential candidate logs onto the Web site hosting the qualitative study. In step 104, the potential candidate enters demographic information such as, but not limited to, geographical location, profession, education, salary, age, gender, political affiliation, etc. In step 106, the potential candidate is trained so that the potential candidate is accustomed to the virtual focus group environment. For instance, one embodiment instructs the potential candidates on how market research studies are conducted and how each party participates. In step 108, follow-up potential candidate interviews are conducted on an as-needed basis should a sponsoring client wish to obtain further information in an effort to finalize the study's candidate pool.

FIG. 1b represents an exemplary flow diagram depicting the enrollment processes for proprietary corporate/membership population samples in accordance with one embodiment of the present invention. In step 152, market research candidates are accumulated from various preexisting databases such as, but not limited to, customer lists, subscriber membership lists, and Web site visitors. In step 154, the market research potential candidate pool is freshly solicited such as through e-mail, direct mail advertisements, and new Web site visitors. In step 156, market research candidates who qualify for the participant pool are sent a participating package. This participating package includes an audio/video capturing device, software for conducting the virtual focus group, and instructions on how to use both the software and the audio/video sensing mechanism. In step 158, proprietary interviews are conducted amongst market research potential participants and the moderator. Should the sponsoring client request further information from a potential participant, follow-up proprietary interviews are conducted in step 162. The proprietary follow-up interview environment conducted in step 162 generally consists of a one-on-one or group “chat room” setting.

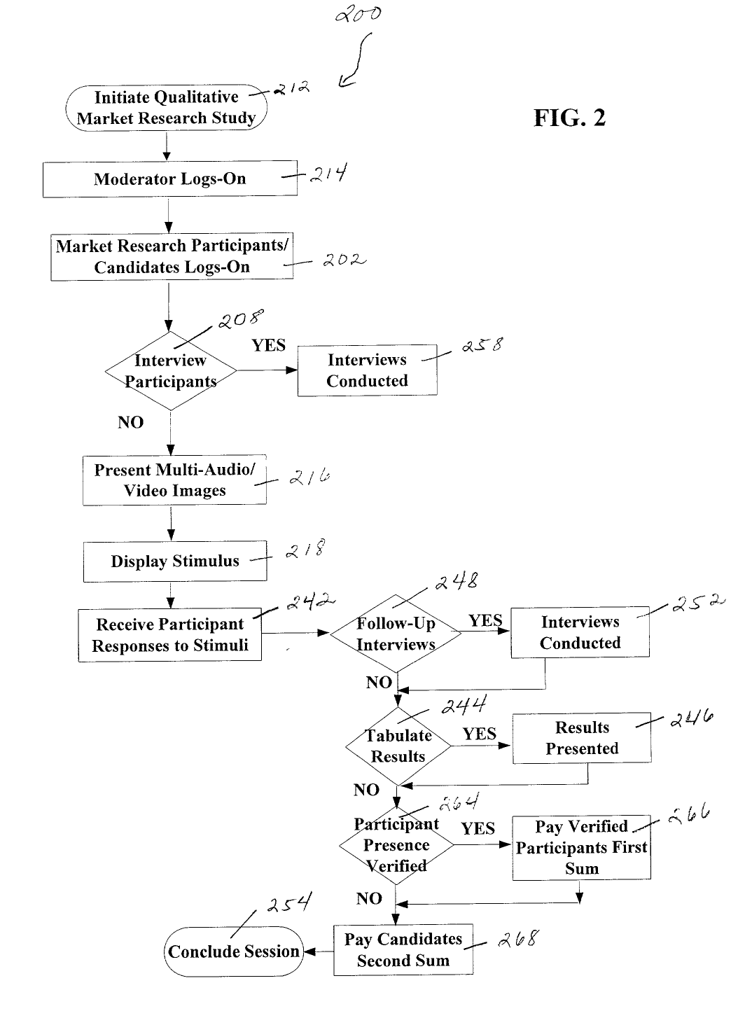

FIG. 2 represents an exemplary flow diagram depicting the process involved in conducting a qualitative study in accordance with one embodiment of the present invention. In step 212, a market research study is initiated amongst the moderator, the candidates, and often an observing, sponsoring company. First, in step 214, the moderator logs onto the Web site hosting the particular market research study using a special market research ID and pass code. During the same time period, in step 202, the market research candidates and participants log onto the Web site hosting the market research study with the participant's own market research ID and pass code. The market research participants comprise a reduced first portion of the set of candidates. After both the market research participants/candidates and moderator have logged on in steps 214 and 202, the moderator in step 208 is asked in step 208 whether or not the moderator wishes to conduct a preliminary interview with anyone. If so, in step 258 an interview is conducted. If not, the study continues with step 216. In step 216, both the moderator and the market research participants are presented with multiple screens in which audio/video images of the moderator and market research participants are displayed. While the moderator has an audio/video image of each market research participant, the market research participant has an audio/video image of themselves, the moderator, and potentially even audio/video images of other participants and their responses. In step 218, a stimulus which represents the product or service the sponsoring company wishes to evaluate is displayed to the participants by the moderator. The stimuli can be, but is not limited to, products, packaging, photos, concept statements, illustrations and/or full motion videos. After the market research participants are shown the stimulus in step 218, they are asked to submit responses to the stimulus in step 242.

Once the session is over, the sponsoring company is asked in step 248, whether the sponsoring client wishes to conduct follow-up interviews with any of the market research participants. Should the sponsoring client wish for follow-up interviews in step 248, the follow-up interviews are conducted in step 252. If not, the sponsoring company is asked in step 244, whether they wish to tabulate the market research study. Should the sponsoring client wish to tabulate the results in step 244 in step 246, the tabulation is presented. If not, then in step 264 the participants' presence throughout the market research study is verified. If the participants have been present throughout the study in step 264, then the participants are paid a first sum of money in step 266.

However, if the participants have not been present throughout the study in step 264, then the candidates are paid in step 268. Sponsoring company's discretion determines whether participants with unverifiable presence receive a second sum like the candidates or receive no payment. Candidates receive a reduced second sum. Candidates are paid less than participants because while they logged onto the study at the predetermined time, ultimately the candidates were not chosen to participate in the study. If the sponsoring client does not want follow-up proprietary interviews, the session ends in step 254.

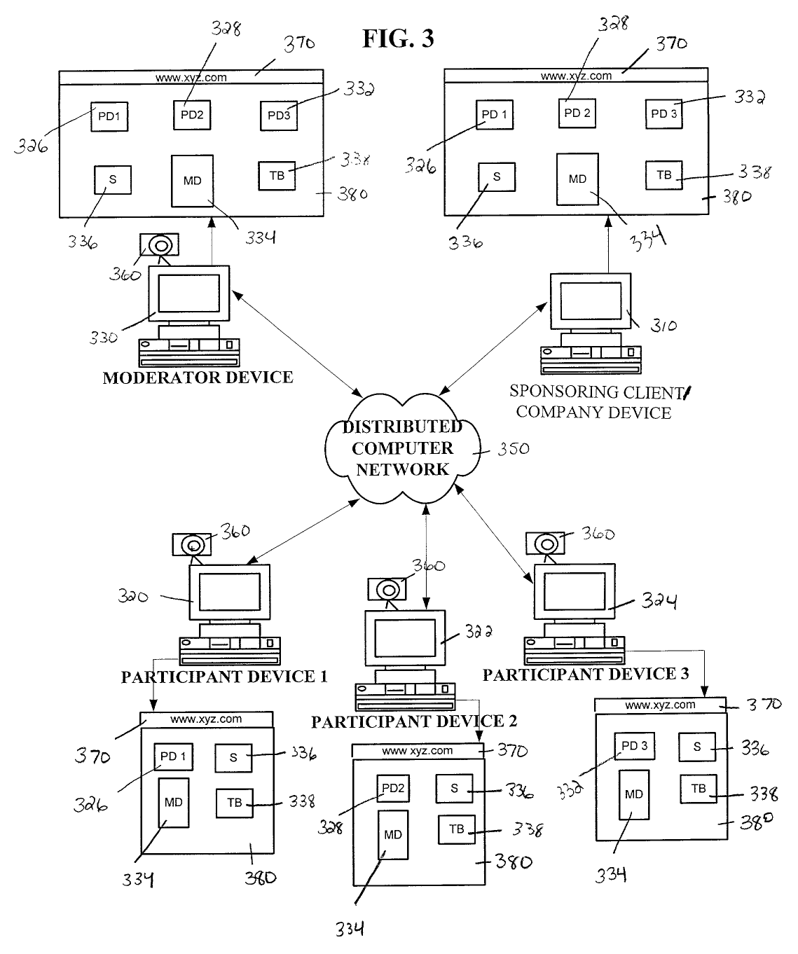

FIG. 3 represents an exemplary network arrangement of a market research study in accordance with one embodiment of the present invention. Then network arrangement 300 is shown in FIG. 3 with three participating market research identities: the moderator, the sponsoring client, and the market research participants. The moderator acts through a moderator device 330, which generally speaking is a PC or a workstation which has Internet or distributed computer network 350 access. In addition, each moderator device 330 has a audio/video capturing device 360 such as a web camera. As can be seen in FIG. 3, the moderator logs onto the hosting market research web site 370, in this case represented by www.xyz.com, and upon entering the hosting market research Web site 370, enters a market research ID and pass code. Upon accessing the market research study, the moderator is presented with a plurality of audio/video participant images as well as written participant responses in substantially real time.

The sponsoring client also observes the market research study through a sponsoring client device 310 which unlike the moderating device 330 is without an active audio/video capturing device. Therefore, from the participant's perspective the sponsoring client silently and anonymously observes the study. Moreover, it should noted that while the sponsoring client does not communicate not with the participants, the sponsoring client through the sponsoring client device 310 can and does communicate with the moderator. The distributed computer access 350 facilitates virtual moderator/sponsoring client conversations. The sponsoring client device 310, like the monitor's device 330, has access to the distributed computer network 350 so that the observing client can log on to the market research study at a given time to observe. In addition, similar to the moderator, the sponsoring client also when logging on to the study views multiple video images which are streamed in substantially real time. In the sponsoring client's web browser 380, multi-video images are depicted by the PD1 box 326, the PD2 box 328, the PD3 box 332 and the MD box 334.

The final party to the market research study is the market research participants. In FIG. 3, the participants also sit at user devices connected to the distributed computer network 350. The participant user devices are labeled as participant device 1 (“PD 1”), 320, participant device 2 (“PD 2”), 322 and participant device 3, (“PD 3”) 324. Each participating device is accompanied with an audio/video capturing device 360 and access to the distributed computer network 350. Each market research participant logs onto the Web site hosting the market research study 370 just as the sponsoring client and the moderator had before them. Also once again, the participants view multiple video images in their web browser 380. Participant 1 who is sitting at PD 1 320 sees a video image of themselves 326 as well as the moderator 334. In addition to seeing video images of the moderator 334 or the participants themselves 326,328, and 332, each market research participant views the stimulus 336 (on another web page). The stimulus 336 is the product or service the sponsoring company is evaluating. In addition, each market research participant has a text box 338 in which participants can submit participant responses to the moderator. Depending on the sponsoring client's motivation, participant user devices may also include the capability of viewing other participant images and submitted responses.

Returning now to the moderator's web browser 380, the moderator sees each video image of each market research participant 326, 328, and 332, a video image of the moderator themselves 334, as well as the stimulus 336. From the sponsoring client's web browser 380, the sponsoring client views the entire virtual communication facility: each market research participant 326, 328, and 332, the moderator 334, the text boxes or submitted responses 338 and the tested stimulus 336.

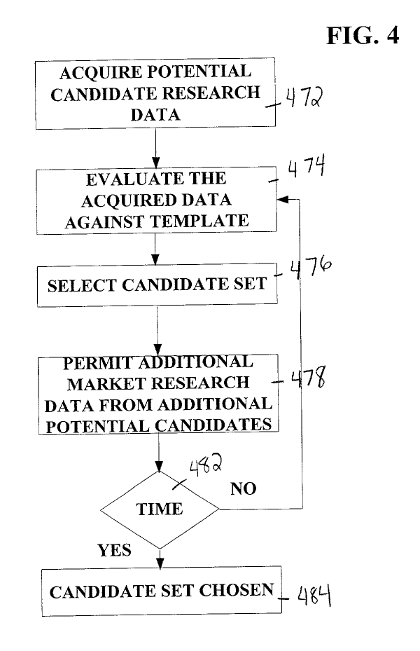

FIG. 4 represents an exemplary flow diagram depicting the process involved when dynamically selecting a set of candidates. First, in step 472 market research data is acquired on a potential candidate set. This market research data is namely demographic information on the potential candidates. At step 472, the potential candidate universe is as expansive as there are people with distributed computer network access. The potential candidate universe represents the world. Then at step 474, the world or the potential candidate universe is evaluated and narrowed. Demographic data submitted by the potential candidate is evaluated in step 474 against a template often provided by the sponsoring client. This template represents to the sponsoring client an ideal market research participant pool at any given time. Once the potential candidate pool has been evaluated in step 474, then in step 476 a candidate set is selected. The candidate set selected in step 476 represents a set of candidates fewer than the potential candidate set. This candidate set has been selected to fit the template in accordance with a predefined preference supplied by the sponsoring company. Next in step 478, additional market research data about other potential candidates is considered in determining the candidate set. This process of evaluating and selecting candidates continues until a time certain. In this way, at any given time, the candidate set will resemble a most ideal market research participant pool. If the sponsoring client determines that that time has been met in step 482, then the candidate set is chosen, information disseminated, and the process ends at step 484. However, until that time comes, the present embodiment will continue acquiring, selecting, and permitting additional market research data such that an optimal candidate set at any given time is chosen.

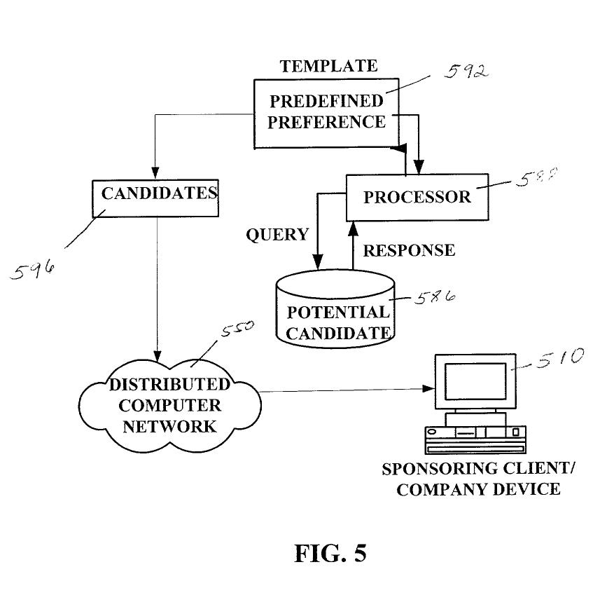

FIG. 5 represents an exemplary network arrangement for dynamically choosing a market research group in accordance with one embodiment of the present invention. As can be seen in FIG. 5, the process for dynamically choosing a market research group is conducted over a distributed computer network 550. The system alerts the sponsoring client 510 of candidates who meet the sponsoring client's prescribed research directive through the distributed computer network.

In essence, the acquired market research data of potential candidates fills a potential candidate database 586. This database 586 can be either a general population sample database or a proprietary corporate/membership database. A processor 588 communicates with both the potential candidate database 586 and a template 592 populated with a predefined preference of potential candidates. Ultimately the processor 588 evaluates the acquired market research data from the potential candidate database 586 in light of the template 592 and selects a set of candidates 596. This candidate 596 set may then be sent over the distributed computer network to the sponsoring client 510 for review.

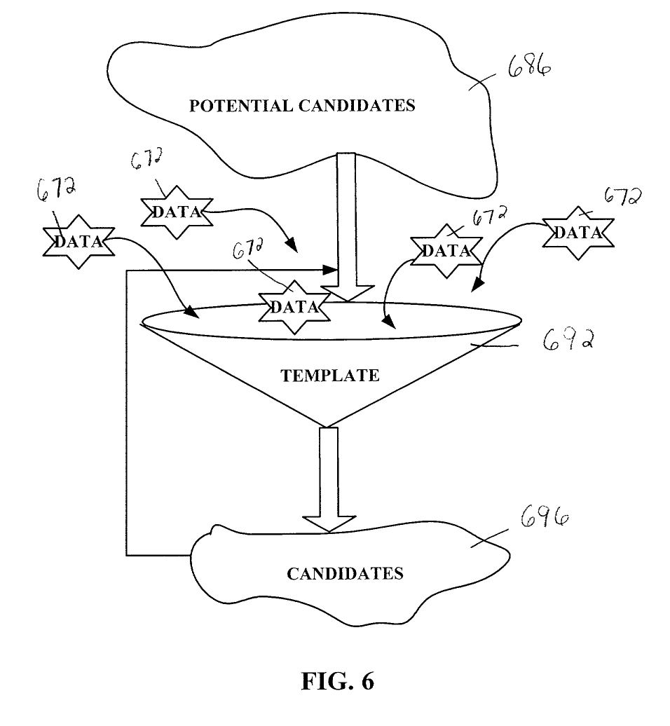

FIG. 6 represents an exemplary template system for dynamically modifying a template to select a set of candidates in accordance with another embodiment of the present invention. Besides acting as a virtual market research study facilitator, and a potential candidate selector, the present invention also acts as a repository of market research information. Sponsoring clients can use the system as a source of study. The potential candidate universe 686 depicted in FIG. 6 comprises of both potential candidates stored in the memory of the potential candidate database 586 as well as potential candidates continually received across the distributed computer network. The candidates in the potential candidate universe 686 are then evaluated through a modifiable template 692 defined by the sponsoring client. The modifiable template 692 specifies the kind of information that the sponsoring client wishes to receive from the potential candidates in the potential candidate universe 686. Once the potential candidates have been evaluated by the modifiable template 692, a set of candidates fewer than the set of potential candidates are selected in accordance with the template 692. Sponsoring clients can further modify the template 692 with additional template data 672. The potential candidates in the potential candidate universe 686 are then evaluated against the modified template 692, resulting in a dynamically selected set of candidates 696 at any given time. In this manner, sponsoring clients utilize the system as a disseminator of market research data and not just as a facilitator of acquiring market research data and candidates.

While the invention has been particularly shown and described with reference to preferred embodiments thereof, it will be understood by those skilled in the art that various changes in form and details may be made therein without departing from the spirit and scope of the invention.

I claim:

1. In a programmed computer, a method for dynamically selecting a set of candidates over a distributed computer network for inclusion in a market research group, comprising, the steps of:
(a) acquiring market research data on potential candidates, the potential candidates connecting to the programmed computer across the distributed computer network;
(b) evaluating the acquired market research data against a template;
(c) selecting a set of candidates in response to the evaluating step, the set of candidates being fewer than the set of potential candidates and being selected to fit the template in accordance with a predefined preference;
(d) permitting additional market research data from additional potential candidates to be acquired across the distributed computer network; and
(e) repeating steps (b) through (d), so that
the permitting step continually acquires market research data, the evaluating step continually evaluates the market research data, and the selecting step dynamically selects the set of candidates so as to optimally fit the predefined preference at a given time.

2. The method as in claim 1, including, the additional step of providing a set of candidates with an audio/video capture mechanism that is connectable to a machine that permits two-way communication across the distributed computer network, the set of candidates comprising a first portion of the set of potential candidates.

3. The method as in claim 2, wherein the acquired market research data includes an image of the potential candidate.

4. The method as in claim 3, including, the additional step of conducting a market research study over the distributed computer network with the set of participants, the set of participants comprising a first portion of a set of candidates.

5. The method as in claim 4, including, the additional steps of:
paying each participant a first sum for participating in the market research study; and,
paying a non-overlapping remainder portion of the set of candidates a second sum which is less than the first sum.

6. The method as in claim 5, including, the additional steps of:
acquiring an image of each participant during the course of the conducted market research study;
comparing each participant image to the potential candidate image acquired with the market research data;
wherein the step of paying each participant comprises paying each participant for which the comparing step results in a match.

7. The method as in claim 4, including, the additional conducting step of:
displaying a stimulus to the participants across the distributed computer network; and,
receiving participant response to the stimulus across the distributed computer network.

8. The method as in claim 7, wherein the comparing step is performed throughout the market research study to verify participant presence.

9. The method as in claim 8, including, the additional step of:
paying each verified participant a first sum for participating in the market research study and paying a non-overlapping remainder portion of the set of candidates a second sum which is less than the first sum.

10. The method as in claim 7, including, the additional step of officiating a follow-up interview with a participant, wherein the moderator displays additional stimulus and receives additional participant response in response to the additional stimulus.

11. A method as in claim 1 which further comprises the additional step of
disseminating information between the set of candidates and a client at the given time.

12. A method for conducting a market research study from a host machine over a distributed computer network, comprising, the steps of:
inviting a set of candidates to a market research study conducted during a predetermined time interval and conducted over a distributed computer network, wherein the candidates access the host using a respective user machine interface having an audio/video captive mechanism connected thereto;
initiating audio/video communication between the host and the user machines with at least a set of participants comprising a first portion of a set of candidates, during the predetermined time interval in substantially real time;
exhibiting a stimulus to the participants; and
accumulating participant responses to the stimulus over the distributed network at the host.

13. The method of conducting a market research study as in claim 12, including, the additional step of verifying a presence each participant throughout the market research study.

14. The method of conducting a market research study as in claim 13, including, 2 the additional step of paying the verified participants a first sum for participating in the market research study and paying a non-overlapping remainder portion of the set of candidates a second sum which is less than the first sum.

15. The method of conducting a market research study as in claim 12, including, the additional step of officiating a follow-up interview with a particular participant subset.

16. The method of conducting a market research study as in claim 12, including, the additional step of selecting groups of participants for a predetermined stimulus, wherein the predetermined stimulus is unique to the participant group.

17. The method of conducting a market research study as in claim 12, including, the additional step of dynamically selecting a particular stimulus in response to prior participant responses.

18. The method of conducting a market research study as in claim 12, including, the additional step of tabulating results of the market research study.

19. A system for dynamically choosing a market research group in accordance with a prescribed research directive of a market research study over a distributed computer network, the market research group having a set of candidates, comprising:
a potential candidate database filled with acquired market research data of the potential candidates;
a template populated with a predefined preference of potential candidates in accordance with the prescribed research directive of the market research study; and
a processor evaluating the acquired market research data in accordance with the predefined preference and optimally selecting candidates in response to the evaluation.

20. The system for dynamically choosing a market research group as in claim 19 wherein the potential candidate database continuously fills and the processor continuously evaluates, dynamically selecting the candidates to optimally fit the predefined preference at a given time.

21. A system for conducting a market research study over a distributed computer network, comprising:
a moderator device having distributed computer network access, an audio/video recording mechanism, and an input mechanism wherein moderators submit stimulus to users across the distributed computer network;
a user device having distributed computer network access, an audio/video recording mechanism, and an input mechanism wherein users submit market research responses in response to the moderator's submitted stimulus; and
a host machine communicating over the distributed computer network and having a database accumulating user responses to the moderator's submitted stimulus, a processor evaluating user responses, and an engine outputting market research results.

22. The system as in claim 21, further comprising, a sponsoring client device having distributed computer network access wherein a sponsoring client accessing the market research study at a given time observes the submitted moderator stimuli and the submitted user responses.

23. The system as in claim 21, wherein a user working from the user device observes a moderator working from a moderating device, the submitted moderator stimuli, and the submitted user response.

24. The system as in claim 21, wherein a user working from the user device further observes a self-image of the user.

25. The system as in claim 21, wherein a user working from the user device further observes a set of participant images.

26. The system as in claim 21, wherein the user working from the user device further observes a set of submitted participant responses.

27. In a programmed computer, a method for dynamically modifying a template used to select a set of candidates over a distributed computer network for inclusion in a market research group, comprising, the steps of:
(a) acquiring template data concerning potential candidates;
(b) modifying the template using the acquired template data;
(c) evaluating the potential candidates against the modified template;
(d) selecting a set of candidates in response to the evaluating step, the set of candidates being fewer than the set of potential candidates and being selected to fit the modified template; and
(e) repeating steps (a)-(d) such that the selecting step dynamically selects the set of candidates that optimally fits the template at a given time.

28. A method as in claim 27, the potential candidates received from a data store memory and used in the evaluating step .

29. A method as in claim 27, the potential candidates continually received over the distributed computer network and used in the evaluating step.

30. A method as in claim 28, the potential candidates continually received over the distributed computer network and used in the evaluating step.

31. A method as in claim 28 which further comprises the additional step of disseminating information between the set of candidates and a client at the given time.
